(19) United States
(12) Patent Application Publication
(10) Pub. No.: US 2022/0010439 A1
(43) Pub. Date: Jan. 13, 2022

(54) METHOD FOR PRODUCING AN ACTIVE LAYER OF AN ELECTRODE FOR ELECTROCHEMICAL REDUCTION REACTIONS

(71) Applicant: IFP Energies nouvelles, Rueil-Malmaison Cedex (FR)

(72) Inventors: Audrey BONDUELLE-SKRZYPCZAK, Rueil-Malmaison Cedex (FR); Sofiane BELAID, Rueil-Malmaison Cedex (FR); Philibert LEFLAIVE, Rueil-Malmaison Cedex (FR); Gerhard PIRNGRUBER, Rueil-Malmaison Cedex (FR)

(73) Assignee: IFP Energies nouvelles, Rueil-Malmaison Cedex (FR)

(21) Appl. No.: 17/295,206

(22) PCT Filed: Nov. 19, 2019
(86) PCT No.: PCT/EP2019/081708

§ 371 Date: May 19, 2021

(30) Foreign Application Priority Data
Nov. 30, 2018 (FR) 1872176

(51) Int. Cl. C25B 11/081; C25B 1/27; C25B 11/063; C25B 11/065; C25B 11/091; C25B 9/17; C25B 3/26; C25B 1/04; C25B 5/00

(52) U.S. Cl. CPC C25B 11/081; C25B 1/27; C25B 11/063; C25B 11/065; C25B 5/00; C25B 9/17; C25B 3/26; C25B 1/04; C25B 11/091

(57) ABSTRACT

A process for the preparation of a catalytic material of an electrode for electrochemical reduction reactions, said material comprising an active phase based on at least one metal from group VIb and an electroconductive support, which process is carried out according to at least the following stages:

a stage of bringing said support into contact with at least one solution containing at least one precursor of at least one metal from group VIb;

a drying stage at a temperature of less than 250° C., without a subsequent calcination stage;

a stage of sulfurization at a temperature of between 100° C. and 600° C.

### TECHNICAL FIELD

The present invention relates to the field of electrodes capable of being used for electrochemical reduction reactions, in particular for the electrolysis of water in a liquid electrolytic medium in order to produce hydrogen.

### STATE OF THE ART

During recent decades, significant efforts in research and development have been carried out to improve the technologies making possible the direct conversion of incident solar radiation into electricity by the photovoltaic effect, the conversion into electricity of the energy of moving air masses by virtue of wind turbines or the conversion into electricity, by virtue of hydroelectric processes, of the potential energy of the water of the oceans evaporated and condensed at altitude. Due to their intermittent nature, these renewable energies benefit from being upgraded by combining them with an energy storage system to compensate for their lack of continuity. The possibilities considered are batteries, compressed air, reversible dams or energy carriers, such as hydrogen. For the latter, the electrolysis of water is the most advantageous route because it is a clean production method (no carbon emission when it is coupled with a renewable energy source) and provides hydrogen of high purity.

In water electrolysis cell, the hydrogen evolution reaction (HER) occurs at the cathode and the oxygen evolution reaction (OER) occurs at the anode. The overall reaction is:

H₂O→H₂+1/2 O₂

Catalysts are necessary for both reactions. Different metals have been studied as catalysts for the reaction for the production of molecular hydrogen at the cathode. Today, platinum is the most widely used metal because it exhibits a negligible overvoltage (voltage necessary to dissociate the water molecule) compared to other metals. However, the scarcity and cost (>25 k€/kg) of this noble metal are brakes on the economic development of the hydrogen sector in the long term. This is the reason why, for a number of years now, researchers have been moving toward new catalysts without platinum but based on inexpensive metals which are abundant in nature.

The production of hydrogen by electrolysis of water is fully described in the work: “Hydrogen Production: Electrolysis”, 2015, edited by Agata Godula-Jopek. The electrolysis of water is an electrolytic process which breaks down water into gaseous O₂ and H₂ with the help of an electric current. The electrolytic cell is constituted by two electrodes—usually made of inert metal (inert in the potential and pH zone considered), such as platinum—immersed in an electrolyte (in this instance water itself) and connected to the opposite poles of the direct current source.

The electric current dissociates the water (H₂O) molecule into hydroxide (HO⁻) and hydrogen (H⁺) ions: in the electrolytic cell, the hydrogen ions accept electrons at the cathode in an oxidation/reduction reaction with the formation of gaseous molecular hydrogen (H₂), according to the reduction reaction:

2H⁺+2e⁻→H₂.

The particulars of the composition and of the use of the catalysts for the production of hydrogen by electrolysis of water are widely covered in the literature and mention may be made of a review paper bringing together the families of advantageous materials under development in the last ten years: “Recent Development in Hydrogen Evolution Reaction Catalysts and Their Practical Implementation”, 2015, P. C. K. Vesborg et al., where the authors describe sulfides, carbides and phosphides as potential new electrocatalysts. Among the sulfide phases, dichalcogenides, such as molybdenum sulfide MoS₂, are very promising materials for the hydrogen evolution reaction (HER) due to their high activity, excellent stability and availability, molybdenum and sulfur being abundant elements on earth and of low cost.

Materials based on MoS₂ have a lamellar structure and can be promoted by Ni or Co for the purpose of increasing their electrocatalytic activity. The active phases can be used in bulk form when the conduction of the electrons from the cathode is sufficient or else in the supported state, then bringing into play a support of a different nature. In the latter case, the support must have specific properties:
high specific surface in order to promote the dispersion of the active phase;
very good electron conductivity;
chemical and electrochemical stability under water electrolysis conditions (acidic medium and high potential).

Carbon is the commonest support used in this application. The whole challenge lies in the preparation of this sulfide-based phase on the conductive material.

It is accepted that a catalyst exhibiting a high catalytic potential is characterized by an associated active phase perfectly dispersed at the surface of the support and exhibiting a high active phase content. It should also be noted that, ideally, the catalyst should exhibit accessibility of the active sites with respect to the reactants, in this instance water, while developing a high active surface area, which can result in specific constraints in terms of structure and texture which are suitable for the constituent support of said catalysts.

The usual methods resulting in the formation of the active phase of the catalytic materials for the electrolysis of water consist of a deposit of precursor(s) comprising at least one metal from group VIb, and optionally at least one metal from group VIII, on a support by the “dry impregnation” technique or by the “excess impregnation” technique, followed by at least one optional heat treatment to remove the water and by a final stage of sulfurization which generates the active phase, as mentioned above.

It appears advantageous to find means for the preparation of catalysts for the production of hydrogen by electrolysis of water, making it possible to obtain new catalysts having improved performance qualities. The prior art shows that researchers have turned toward several methods, including the deposition of Mo precursors in the form of ammonium salts or oxides or heptamolybdate, followed by a stage of sulfurization in the gas phase or in the presence of a chemical reducing agent.

By way of example, Chen et al., “Recent Development in Hydrogen Evolution Reaction Catalysts and Their Practical Implementation”, 2011, provide for the synthesis of a MoS₂ catalyst by sulfurization of MoO₃ at different temperatures under a H₂S/H₂ gas mixture with a 10/90 ratio. Kibsgaard et al., “Engineering the surface structure of MoS2 to preferentially expose active edge sites for electrocatalysis”, 2012, provide for the electrodeposition of Mo on a Si support from a peroxopolymolybdate solution and then for the implementation of a stage of sulfurization at 200° C. under a H₂S/H₂ gas mixture with a 10/90 ratio. Bonde et al., “Hydrogen evolution on nano-particulate transition metal sulfides”, 2009, provide for the impregnation of a carbon support with an aqueous ammonium heptamolybdate solution, for drying it in air at 140° C. and then for carrying out a sulfurization at 450° C. under a H₂S/H₂ gas mixture with a 10/90 ratio for 4 hours. Benck et al., “Amorphous Molybdenum Sulfide Catalysts for Electrochemical Hydrogen Production: Insights into the Origin of their Catalytic Activity”, 2012, synthesized a MoS₂ catalyst by mixing an aqueous ammonium heptamolybdate solution with a sulfuric acid solution and then, in a second stage, a sodium sulfide solution in order to form MoS₂ nanoparticles.

A method of preparation consisting of the decomposition of a thiomolybdic salt by virtue of a reducing agent should also be pointed out. Li et al., “MoS₂ Nanoparticles Grown on Graphene: An Advanced Catalyst for Hydrogen Evolution Reaction”, 2011, thus synthesized a MoS₂ catalyst on a graphene support starting from (NH₄)₂MoS₄, a DMF solution and a N₂H₄.H₂O solution.

The applicant company has developed a new process for the preparation of a catalytic material making it possible to obtain an electrode which can be used in an electrolytic cell for carrying out an electrochemical reduction reaction, and more particularly which makes it possible to obtain a cathode which can be used in an electrolytic cell for the production of hydrogen by electrolysis of water. This is because the applicant company has discovered that the deposition of at least one metal from group VIb in the presence of an organic molecule on an electroconductive support makes it possible to obtain catalytic performance qualities which are at least as good, indeed even better, in particular when the latter is used as catalytic phase of an electrode for electrochemical reduction reactions, and this even more particularly when the catalytic material is used as catalytic phase of a cathode for the production of hydrogen by electrolysis of water.

### SUMMARY OF THE INVENTION

A first subject matter of the present invention is a process for the preparation of a catalytic material of an electrode for electrochemical reduction reactions, said material comprising an active phase based on at least one metal from group VIb and an electroconductive support, which process is carried out according to at least the following stages:

a) a stage of bringing said support into contact with at least one solution containing at least one precursor of at least one metal from group VIb;
b) optionally a stage of bringing the support into contact with an organic additive, it being understood that stage b) is obligatory when said precursor of at least one metal from group VIb according to stage a) is chosen from polyoxometallates corresponding to the formula (HₕXₓMₘO_{y})^{q-} in which H is hydrogen, X is an element chosen from phosphorus (P), silicon (Si), boron (B), nickel (Ni) and cobalt (Co), M is one or more metal(s) chosen from molybdenum (Mo), tungsten (W), nickel (Ni), cobalt (Co) and iron (Fe), O being oxygen, h being an integer between 0 and 12, x=0, m being an integer equal to 5, 6, 7, 8, 9, 10, 11, 12 and 18, y being an integer between 17 and 72 and q being an integer between 1 and 20, it being understood that M is not a nickel atom, a cobalt atom or an iron atom alone.
stages 1) and 2), if both carried out, being carried out in any order or simultaneously;
c) a drying stage on conclusion of stage a), optionally of the sequence of stages a) and b) or b) and a), at a temperature of less than 250° C., without a subsequent calcination stage;
d) a stage of sulfurization of the material obtained on conclusion of stage c) at a temperature of between 100° C. and 600° C.

Preferably, said precursor of at least one metal from group VIb is chosen from polyoxometallates corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20; salts of precursors of the elements from group VIb, such as molybdates, thiomolybdates, tungstates or also thiotungstates; organic or inorganic precursors based on Mo or W, such as MoCl₅ or WCl₄ or WCl₆, and Mo or W alkoxides. More preferentially, said precursor is chosen from polyoxometallates corresponding to the formula (HₕXₓMₘO_{y})^{q-} as are formulated above.

Advantageously, the m atoms M are either solely molybdenum (Mo) atoms, or solely tungsten (W) atoms, or a mixture of molybdenum (Mo) and tungsten (W) atoms, or a mixture of molybdenum (Mo) and cobalt (Co) atoms, or a mixture of molybdenum (Mo) and nickel (Ni) atoms, or a mixture of tungsten (W) and nickel (Ni) atoms.

Advantageously, the m atoms M are either a mixture of nickel (Ni), molybdenum (Mo) and tungsten (W) atoms or a mixture of cobalt (Co), molybdenum (Mo) and tungsten (W) atoms. Advantageously, said process comprises an additional stage of introduction of at least one promoter comprising at least one metal from group VIII by a stage of bringing said support into contact with at least one solution containing at least one precursor of at least one metal from group VIII.

Preferably, a maturation stage is carried out after stage a) and/or b) but before stage c), at a temperature of between 10° C. and 50° C. for a period of time of less than 48 hours.

Preferably, the drying stage c) is carried out at a temperature of less than 180° C.

Preferably, when the precursor of the catalytic material comprises at least one metal from group VIb and at least one metal from group VIII, the sulfurization temperature in stage d) is between 350° C. and 550° C.

Preferably, when the precursor of the catalytic material comprises solely a metal from group VIb, the sulfurization temperature in stage d) is between 100° C. and 250° C. or between 400° C. and 600° C.

Advantageously, the organic additive is chosen from:
chelating agents, nonchelating agents, reducing agents or nonreducing agents;
mono-, di- or polyalcohols, carboxylic acids, sugars, noncyclic mono-, di- or polysaccharides, esters, ethers, crown ethers, cyclodextrins and organic compounds containing sulfur or nitrogen.

In one embodiment according to the invention, the support comprises at least one material chosen from carbon structures of the carbon black, graphite, carbon nanotubes or graphene type.

In one embodiment according to the invention, the support comprises at least one material chosen from gold, copper, silver, titanium or silicon.

Another subject matter according to the invention relates to an electrode, characterized in that it is formulated by a preparation process comprising the following stages:

1) at least one ionic conductive polymer binder is dissolved in a solvent or a solvent mixture;
2) at least one catalytic material prepared according to the invention, in powder form, is added to the solution obtained in stage 1) in order to obtain a mixture;
stages 1) and 2) being carried out in any order or simultaneously;
3) the mixture obtained in stage 2) is deposited on a metallic or metallic-type conductive support or collector.

Another subject matter according to the invention relates to an electrolysis device comprising an anode, a cathode and an electrolyte, said device being characterized in that one at least of the anode or of the cathode is an electrode according to the invention.

Another subject matter according to the invention relates to the use of the electrolysis device according to the invention in electrochemical reactions, and more particularly as:
water electrolysis device for the production of a gaseous mixture of hydrogen and oxygen and/or the production of hydrogen alone;
carbon dioxide electrolysis device for the production of formic acid,
nitrogen electrolysis device for the production of ammonia;
fuel cell device for the production of electricity from hydrogen and oxygen.

### DETAILED DESCRIPTION OF THE INVENTION

### Definitions

Subsequently, the groups of chemical elements are given according to the CAS classification (CRC Handbook of Chemistry and Physics, published by CRC Press, editor D. R. Lide, 81^{st} edition, 2000-2001). For example, group VIII according to the CAS classification corresponds to the metals from columns 8, 9 and 10 according to the new IUPAC classification.

BET specific surface is understood to mean the specific surface determined by nitrogen adsorption in accordance with the standard ASTM D 3663-78 drawn up from the Brunauer-Emmett-Teller method described in the periodical The Journal of the American Chemical Society, 60, 309 (1938).

### Preparation Process

The process for the preparation of a catalytic material of an electrode for electrochemical reduction reactions, said material comprising an active phase based on at least one metal from group VIb and an electroconductive support, comprises at least the following stages:

a) a stage of bringing said support into contact with with least one solution containing at least one precursor of at least one metal from group VIb;
b) optionally a stage of bringing the support into contact with an organic additive, it being understood that stage b) is obligatory when said precursor of at least one metal from group VIb according to stage a) is chosen from polyoxometallates corresponding to the formula (HₕXₓMₘO_{y})^{q-} in which H is hydrogen, X is an element chosen from phosphorus (P), silicon (Si), boron (B), nickel (Ni) and cobalt (Co), M is one or more metal(s) chosen from molybdenum (Mo), tungsten (W), nickel (Ni), cobalt (Co) and iron (Fe), O being oxygen, h being an integer between 0 and 12, x=0, m being an integer equal to 5, 6, 7, 8, 9, 10, 11, 12 and 18, y being an integer between 17 and 72 and q being an integer between 1 and 20, it being understood that M is not a nickel atom, a cobalt atom or an iron atom alone.
stages 1) and 2), if both carried out, being carried out in any order or simultaneously;
c) a drying stage on conclusion of stage a), optionally of the sequence of stages a) and b) or b) and a), at a temperature of less than 250° C., without a subsequent calcination stage;
d) a stage of sulfurization of the material obtained on conclusion of stage c) at a temperature of between 100° C. and 600° C.

### Stage a)

In accordance with stage a) of the preparation process according to the invention, at least one stage of bringing the support into contact with at least one solution containing at least one precursor of the active phase comprising at least one metal from group VIb is carried out. Advantageously, the stage of bringing the support into contact with at least one precursor of the active phase comprising at least one metal from group VIb (and optionally at least one metal from group VIII), in accordance with the implementation of stage a), can be carried out by dry impregnation or excess impregnation, or also by deposition—precipitation, according to methods well known to a person skilled in the art. Preferably, said stage a) is carried out by dry impregnation, which consists in bringing the support into contact with a solution containing at least one precursor comprising at least one metal of group VIb (and optionally from group VIII), the volume of the solution of which is between 0.25 and 1.5 times the pore volume of the support to be impregnated.

### Precursors Comprising at Least One Metal from Group VIb

The precursors comprising at least one metal from group VIb can be chosen from all the precursors of the elements from group VIb known to a person skilled in the art. They can be chosen from polyoxometallates (POMs) or salts of precursors of the elements from group VIb, such as molybdates, thiomolybdates, tungstates or also thiotungstates. They can be chosen from organic or inorganic precursors, such as MoCl₅ or WCl₄ or WCl₆ or Mo or W alkoxides, for example Mo(OEt)₅ or W(OEt)₅.

In the context of the present invention, polyoxometallates (POMs) are understood as being the compounds corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20.

Preferably, the element M cannot be a nickel atom, a cobalt atom or an iron atom alone.

The polyoxometallates defined according to the invention encompass two families of compounds: isopolyanions and heteropolyanions. These two families of compounds are defined in the paper Heteropoly and Isopoly Oxometallates, Pope, published by Springer-Verlag, 1983.

The isopolyanions which can be used in the present invention are polyoxometallates of general formula (HₕXₓMₘO_{y})^{q-} in which x=0, the other elements having the abovementioned meaning. Preferably, the m atoms M of said isopolyanions are either solely molybdenum atoms, or solely tungsten atoms, or a mixture of molydene and tungsten atoms, or a mixture of molybdenum and cobalt atoms, or a mixture of molybdenum and nickel atoms, or a mixture of tungsten and cobalt atoms, or a mixture of tungsten and nickel atoms.

The m atoms M of said isopolyanions can also be either a mixture of nickel, molybdenum and tungsten atoms or a mixture of cobalt, molybdenum and tungsten atoms.

Preferably, in the case where the element M is molybdenum (Mo), m is equal to 7. Likewise, preferably, in the case where the element M is tungsten (W), m is equal to 12.

The Mo₇O₂₄⁶⁻ and H₂W₁₂O₄₀⁶⁻ isopolyanions are advantageously used as active phase precursors in the context of the invention.

The heteropolyanions which can be used in the present invention are polyoxometallates of formula (HₕXₓMₘO_{y})^{q-} in which x=1, 2, 3 or 4, the other elements having the abovementioned meanings.

The heteropolyanions generally exhibit a structure in which the element X is the “central” atom and the element M is a metal atom virtually systematically in octahedral coordination with X other than M.

Preferably, the m atoms M are either solely molybdenum atoms, or solely tungsten atoms, or a mixture of molybdenum and cobalt atoms, or a mixture of molybdenum and nickel atoms, or a mixture of tungsten and molybdenum atoms, or a mixture of tungsten and cobalt atoms, or a mixture of tungsten and nickel atoms. Preferably, the m atoms M are either solely molybdenum atoms, or a mixture of molybdenum and cobalt atoms, or a mixture of molybdenum and nickel. Preferably, the m atoms M cannot be solely nickel atoms or solely cobalt atoms.

Preferably, the element X is at least one phosphorus atom or one Si atom.

Heteropolyanions are negatively charged polyoxometallate entities. In order to compensate for these negative charges, it is necessary to introduce counterions and more particularly cations. These cations can advantageously be protons H⁺, or any other cation of NH₄⁺ type, or metal cations and in particular metal cations of metals from group VIII.

In the case where the counterions are protons, the molecular structure comprising the heteropolyanion and at least one proton constitutes a heteropolyacid. The heteropolyacids which can be used as active phase precursors in the present invention can, by way of example, be phosphomolybdic acid (3H⁺.PMo₁₂O₄₀³⁻) or also phosphotungstic acid (3H⁺.PW₁₂O₄₀³⁻).

In the case where the counterions are not protons, reference is then made to heteropolyanion salt in order to designate this molecular structure. It is then possible to advantageously take advantage of the combination within the same molecular structure, via the use of a heteropolyanion salt, of the metal M and of its promoter, that is to say of the element cobalt and/or of the element nickel, which can either be in position X within the structure of the heteropolyanion, or in partial replacement of at least one atom M of molybdenum and/or of tungsten within the structure of the heteropolyanion, or in a counterion position.

Preferably, the polyoxometallates used according to the invention are the compounds corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 6, x being an integer which can be equal to 0, 1 or 2, m being an integer equal to 5, 6, 7, 9, 10, 11 and 12, y being an integer between 17 and 48 and q being an integer between 3 and 12.

More preferably, the polyoxometallates used according to the invention are the compounds corresponding to the formula (HₕXₓMₘO_{y})^{q-}, h being an integer equal to 0, 1, 4 or 6, x being an integer equal to 0, 1 or 2, m being an integer equal to 5, 6, 10 or 12, y being an integer equal to 23, 24, 38 or 40 and q being an integer equal to 3, 4, 6 and 7, H, X, M and O having the abovementioned meanings.

The preferred polyoxometallates used according to the invention are advantageously chosen from polyoxometallates of formula PMo₁₂O₄₀³⁻, HPCoMo₁₁O₄₀⁶⁻, HPNiMo₁₁O₄₀⁶⁻, P₂Mo₅O23⁶⁻, Co₂Mo₁₀O₃₈H4⁶⁻ or CoMo₆O₂₄H₆⁴⁻, taken alone or as a mixture.

Preferred polyoxometallates which can advantageously be used in the process according to the invention are the “Anderson” heteropolyanions of general formula XM₆O₂₄^{q-} for which the m/x ratio is equal to 6 and in which the elements X and M and the charge q have the abovementioned meanings. The element X is thus an element chosen from phosphorus (P), silicon (Si), boron (B), nickel (Ni) and cobalt (Co), said element being taken alone, M is one or more element(s) chosen from molybdenum (Mo), tungsten (W), nickel (Ni) and cobalt (Co), and q is an integer between 1 and 20 and preferably between 3 and 12.

The specific structure of said “Anderson” heteropolyanions is described in the paper Nature, 1937, 150, 850. The structure of said “Anderson” heteropolyanions comprises 7 octahedra located in one and the same plane and connected together by the edges: out of the 7 octahedra, 6 octahedra surround the central octahedron containing the element X.

The Anderson heteropolyanions containing, within their structure, cobalt and molybdenum or nickel and molybdenum are preferred. The Anderson heteropolyanions of formulae CoMo₆O24H₆³⁻ and NiMo₆O₂₄H₆⁴⁻ are particularly preferred. In accordance with the formula, in these Anderson heteropolyanions, the cobalt and nickel atoms are respectively the X heteroelements of the structure.

In the case where the Anderson heteropolyanion contains, within its structure, cobalt and molybdenum, a mixture of the two forms, monomeric of formula CoMo₆O₂₄H₆³⁻ and dimeric of formula Co₂Mo₁₀O₃₈H4⁶⁻, of said heteropolyanion, the two forms being in equilibrium, can advantageously be used. In the case where the Anderson heteropolyanion contains, within its structure, cobalt and molybdenum, said Anderson heteropolyanion is preferably dimeric, of formula Co₂Mo₁₀O₃₈H₄⁶⁻.

In the case where the Anderson heteropolyanion contains, within its structure, nickel and molybdenum, a mixture of the two forms, monomeric of formula NiMo₆O₂₄H₆⁴⁻ and dimeric of formula Ni₂Mo₁₀O₃₈H₄⁸⁻, of said heteropolyanion, the two forms being in equilibrium, can advantageously be used. In the case where the Anderson heteropolyanion contains, within its structure, nickel and molybdenum, said Anderson heteropolyanion is preferably monomeric, of formula NiMo₆O₂₄H₆⁴⁻.

Anderson heteropolyanion salts can also advantageously be used as active phase precursors according to the invention. Said Anderson heteropolyanion salts are advantageously chosen from cobalt or nickel salts of the monomeric 6-molybdocobaltate ion respectively of formula CoMo₆O₂₄H₆³⁻.3/2Co²⁺ or CoMo₆O₂₄H₆³⁻.3/2Ni²⁺ exhibiting an atomic ratio of said promoter (Co and/or Ni)/Mo of 0.41, the cobalt or nickel salts of the dimeric decamolybdocobaltate ion of formula Co₂Mo₁₀O₃₈H₄⁶⁻.3Co²⁺ or Co₂Mo₁₀O₃₈H₄⁶⁻.3Ni²⁺ exhibiting an atomic ratio of said promoter (Co and/or Ni)/Mo of 0.5, the cobalt or nickel salts of the 6-molybdonickellate ion of formula NiMo₆O₂₄H₆⁴⁻.2Co²⁺ or NiMo₆O₂₄H₆⁴⁻.2Ni²⁺ exhibiting an atomic ratio of said promoter (Co and/or Ni)/Mo of 0.5, and the cobalt or nickel salts of the dimeric decamolybdonickellate ion of formula Ni₂Mo₁₀O₃₈H₄⁸⁻.4Co²⁺ or Ni₂Mo₁₀O₃₈H₄⁸⁻.4Ni²⁺ exhibiting an atomic ratio of said promoter (Co and/or Ni)/Mo of 0.6.

The very preferred Anderson heteropolyanion salts used in the invention are chosen from the dimeric heteropolyanion salts including cobalt and molybdenum within their structure of formulae Co₂Mo₁₀O₃₈H₄⁶⁻.3Co²⁺ and Co₂Mo₁₀O₃₈H₄⁶⁻.3Ni²+. An even more preferred Anderson heteropolyanion salt is the dimeric Anderson heteropolyanion salt of formula Co₂Mo₁₀O₃₈H₄⁶⁻.3Co²⁺.

Other preferred polyoxometallates which can advantageously be used in the process according to the invention are the “Keggin” heteropolyanions of general formula XM₁₂O₄₀^{q-} for which the m/x ratio is equal to 12 and the “lacunary Keggin” heteropolyanions of general formula XM₁₁O₃₉^{q-} for which the m/x ratio is equal to 11 and in which the elements X and M and the charge q have the abovementioned meanings. X is thus an element chosen from phosphorus (P), silicon (Si), boron (B), nickel (Ni) and cobalt (Co), said element being taken alone, M is one or more element(s) chosen from molybdenum (Mo), tungsten (W), nickel (Ni) and cobalt (Co), and q is an integer between 1 and 20 and preferably between 3 and 12.

Said Keggin entities are advantageously obtained for pH ranges which can vary according to the production routes described in the publication by A. Griboval, P. Blanchard, E. Payen, M. Fournier and J. L. Dubois, Chem. Lett., 1997, 12, 1259.

A preferred Keggin heteropolyanion, advantageously used according to the invention, is the heteropolyanion of formula PMo₁₂O₄₀³⁻ or PW₁₂O₄₀³⁻ or SiMo₁₂O₄₀⁴⁻ or SiW₁₂O₄₀⁴⁻.

The preferred Keggin heteropolyanion can also advantageously be used in the invention in its heteropolyacid form of formula PMo₁₂O₄₀³⁻.3H⁺ or PW₁₂O₄₀³⁻.3H⁺ or SiMo₁₂O₄₀⁴⁻.4H⁺ or SiW₁₂O₄₀⁴⁻.4H⁺.

Salts of heteropolyanions of Keggin or lacunary Keggin type can also advantageously be used according to the invention. Preferred salts of heteropolyanions or heteropolyacids of Keggin and lacunary Keggin type are advantageously chosen from the cobalt or nickel salts of phosphomolybdic, silicomolybdic, phosphotungstic or silicitungstic acids. Said salts of heteropolyanions or of heteropolyacids of Keggin or lacunary Keggin type are described in the patent U.S. Pat. No. 2,547,380. Preferably, a salt of heteropolyanion of Keggin type is nickel phosphotungstate of formula 3/2Ni²+.PW₁₂O₄₀³⁻ exhibiting an atomic ratio of the metal from group VIb to the metal from group VIII, that is to say Ni/W, of 0.125.

Another preferred polyoxometallate which can advantageously be used as precursor employed in the process according to the invention is the Strandberg heteropolyanion of formula HₕP₂Mo₅O₂₃^{(6-h)-}, h being equal to 0, 1 or 2 and for which the m/x ratio is equal to 5/2.

The preparation of said Strandberg heteropolyanions and in particular of said heteropolyanion of formula HₕP₂Mo₅O₂₃^{(6-h)-} is described in the paper by W-C. Cheng and N. P. Luthra, J. Catal., 1988, 109, 163.

Thus, by virtue of various preparation methods, many polyoxometallates and their associated salts are available. In general, all these polyoxometallates and their associated salts can advantageously be used during the electrolysis carried out in the process according to the invention. However, the preceding list is not exhaustive and other combinations can be envisaged.

### Precursors Comprising at Least One Metal From Group VIII

The preferred elements from group VIII are nonnoble elements: they are chosen from Ni, Co and Fe. Preferably, the elements from group VIII are Co and Ni. The metal from group VIII can be introduced in the form of salts, chelating compounds, alkoxides or glycoxides. The sources of elements from group VIII which can advantageously be used in the form of salts are well known to a person skilled in the art. They are chosen from nitrates, sulfates, hydroxides, phosphates, carbonates and halides chosen from chlorides, bromides and fluorides.

Said precursor comprising at least one metal from group VIII is partially soluble in an aqueous phase or in an organic phase. The solvents used are generally water, an alkane, an alcohol, an ether, a ketone, a chlorinated compound or an aromatic compound. Aqueous acid solution, toluene, benzene, dichloromethane, tetrahydrofuran, cyclohexane, n-hexane, ethanol, methanol and acetone are preferably used.

The metal from group VIII is preferably introduced in the acetylacetonate or acetate form when an organic solvent is used, in the nitrate form when the solvent is water and in the hydroxide or carbonate or hydroxycarbonate form when the solvent is water at acidic pH, i.e. less than 7, advantageously less than 2.

Preferably, said precursor comprising at least one metal from group VIII is introduced either:

i) before the contacting stages a) and optionally b), in a “preimpregnation” stage a1) using a solution comprising at least one precursor comprising at least one metal from group VIII;
ii) during the contacting stage a), in cocontacting with said solution comprising at least one precursor comprising at least one metal from group VIb;
iii) after the drying stage a), in a “postimpregnation” stage c1) using a solution containing at least one precursor comprising at least one metal from group VIII. In this specific embodiment, an optional maturation stage, and a stage of drying at a temperature of less than 250° C., preferably of less than 180° C., can be carried out under the same conditions as the conditions described above;
iv) after the sulfurization stage d), in a “postimpregnation” stage d1) using a solution comprising at least one precursor comprising at least one metal from group VIII. In this specific embodiment, it is optionally possible to carry out a new maturation stage, a new drying stage at a temperature of less than 250° C., preferably of less than 180° C., and optionally a new sulfurization stage, under the same operating conditions as described above.

### Other Promoters

The solutions used in the various impregnation or successive impregnation stages can optionally contain at least one precursor of a doping element chosen from boron, phosphorus and silicon. The precursors of a doping element chosen from boron, phosphorus and silicon can also advantageously be added in impregnation solutions not containing the precursors of at least one metal chosen from the group formed by the metals from group VIII and the metals from group VIb, taken alone or as a mixture.

Said precursors of the metals from group VIII and of the metals from group VIb, the precursors of the doping elements and the organic compounds are advantageously introduced into the impregnation solution(s) in an amount such that the contents of element from group VIII, of element from group VIb, of doping element and of organic additives on the final catalyst are as defined below.

### Stage b) (Optional)

According to one embodiment according to the invention, when the precursor of at least one metal from group VIb according to stage a) is chosen from the polyoxometallates corresponding to the formula (HₕXₓMₘO_{y})^{q-} with x=0, then an additional stage of bringing said electroconductive support into contact with at least one solution containing at least one organic compound is carried out, in accordance with the implementation of stage b), can be carried out by any method well known to a person skilled in the art. In particular, said stage b) can be carried out by dry impregnation or by excess impregnation according to methods well known to a person skilled in the art. Preferably, said stage b) is carried out by dry impregnation, which consists in bringing the support into contact with a volume of said solution of between 0.25 and 1.5 times the pore volume of the support to be impregnated.

Said organic compound can be chosen from all the organic compounds known to a person skilled in the art and is selected in particular from chelating agents, nonchelating agents, reducing agents or nonreducing agents. It can also be chosen from mono-, di- or polyalcohols which are optionally etherified, carboxylic acids, sugars, noncyclic mono-, di- or polysaccharides, such as glucose, fructose, maltose, lactose or sucrose, esters, ethers, crown ethers, cyclodextrins and compounds containing sulfur or nitrogen, such as nitriloacetic acid, ethylenediaminetetraacetic acid or diethylenetriamine, alone or as a mixture.

### Implementation of Stages a) and b)

When the process according to the invention comprises the implementation of stages a) and b, then the process for the preparation of the catalytic material comprises several embodiments. They differ in particular in the order of introduction of the organic compound and of the metal precursor of the active phase, it being possible for the organic compound to be brought into contact with the support either after the metal precursor of the active phase has been brought into contact with the support, or before the metal precursor of the active phase is brought into contact with the support, or simultaneously.

A first embodiment consists in carrying out stage b) before stage a) (preimpregnation).

A second embodiment consists in carrying out stage b) after stage a) (postimpregnation).

A third embodiment consists in carrying out stages a) and b) simultaneously (coimpregnation).

Each stage a) and b) of bringing the support into contact with the metal precursor (stage a)) and of bringing the support into contact with at least one solution containing at least one organic compound (stage b)) is carried out at least once and can advantageously be carried out several times; all the possible combinations of implementations of stages a) and b) come within the scope of the invention.

Each contacting stage can preferably be followed by an intermediate drying stage. The intermediate drying stage is carried out at a temperature of less than 250° C., preferably of between 15° C. and 250° C., more preferentially between 30° C. and 220° C., more preferentially still between 50° C. and 200° C. and in an even more preferential way between 70° C. and 180° C. Advantageously, after each stage of bringing into contact, whether it is a stage of bringing the metal precursor of the active phase into contact or a stage of bringing the organic compound into contact, the impregnated support can be left to mature, optionally before an intermediate drying stage. Maturation makes it possible for the solution to be distributed homogeneously within the support. When a maturation stage is carried out, said stage is advantageously carried out at atmospheric pressure, under an inert atmosphere or under an atmosphere containing oxygen or under an atmosphere containing water or the impregnation solvent, and at a temperature of between 10° C. and 50° C., and preferably at ambient temperature. Generally, a duration of maturation of less than 48 hours and preferably of between 5 minutes and 12 hours is sufficient.

### Drying Stage c)

The drying stage is carried out at a temperature of less than 250° C., preferably of less than 180° C., more preferentially of less than 120° C. Very preferably, the drying is carried out at reduced pressure at a temperature not exceeding 80° C. The drying time is between 30 minutes and 24 hours, preferably between 30 minutes and 16 hours. Preferably, the drying time does not exceed 4 hours.

The drying stage can be carried out by any technique known to a person skilled in the art. It is advantageously carried out under an inert atmosphere or under an atmosphere containing oxygen. It is advantageously carried out at atmospheric pressure or at reduced pressure.

### Sulfurization Stage d)

The sulfurization carried out during stage d) is intended to at least partially sulfurize the metal from group VIb and optionally at least partially sulfurize the metal from group VIII.

The sulfurization stage d) can advantageously be carried out using a H₂S/H₂ or H₂S/N₂ gas mixture containing at least 5% by volume of H₂S in the mixture or under a flow of pure H₂S at a temperature of between 100° C. and 600° C., under a total pressure equal to or greater than 0.1 MPa, for at least 2 hours.

Preferably, when the precursor of the catalytic material comprises the metals from groups VIb and VIII, the sulfurization temperature is between 350° C. and 550° C.

Preferably, when the precursor of the catalytic material comprises only the metals from group VIb, the sulfurization temperature is between 100° C. and 250° C. or between 400° C. and 600° C.

### Catalytic Material

The activity of the catalytic material for the production of hydrogen by electrolysis of water is ensured by an element from group VIb and optionally by at least one element from group VIII. Advantageously, the active phase is chosen from the group formed by the combinations of the elements nickel-molybdenum or cobalt-molybdenum or nickel-cobalt-molybdenum or nickel-tungsten or nickel-molybdenum-tungsten.

When the metal from group VIb is molybdenum, the molybdenum (Mo) content is between 4% and 60% by weight of Mo element, with respect to the weight of the final catalytic material, and preferably between 7% and 50% by weight, with respect to the weight of the final catalytic material, obtained after the last preparation stage, i.e. the sulfurization.

When the metal from group VIb is tungsten, the tungsten (W) content is between 7% and 70% by weight of W element, with respect to the weight of the final catalytic material, and preferably between 12% and 60% by weight, with respect to the weight of the final catalytic material, obtained after the last preparation stage, i.e. the sulfurization.

The surface density, which corresponds to the amount of molybdenum Mo atoms deposited per unit area of support, will advantageously be between 0.5 and 20 atoms of Mo per square nanometer of support and preferably between 2 and 15 atoms of Mo per square nanometer of support.

When the catalytic material comprises at least one metal from group VIII, the content of metal from group VIII is advantageously between 0.1% and 15% by weight of element from group VIII, preferably between 0.5% and 10% by weight, with respect to the total weight of the final catalytic material obtained after the last preparation stage, i.e. the sulfurization.

### Support for the Catalytic Material

The support for the catalytic material is a support comprising at least one electroconductive material.

In one embodiment according to the invention, the support for the catalytic material comprises at least one material chosen from carbon structures of the carbon black, graphite, carbon nanotubes or graphene type.

In one embodiment according to the invention, the support for the catalytic material comprises at least one material chosen from gold, copper, silver, titanium or silicon.

A porous and nonelectroconductive material can be rendered electroconductive by depositing an electroconductive material at the surface thereof; mention may be made, for example, of a refractory oxide, such as an alumina, within which graphitic carbon is deposited.

The support for the catalytic material advantageously exhibits a BET specific surface (SS) of greater than 75 m²/g, preferably of greater than 100 m²/g, very preferably of greater than 130 m²/g.

### Electrode

The catalytic material capable of being obtained by the preparation process according to the invention can be used as electrode catalytic material capable of being used for electrochemical reactions, and in particular for the electrolysis of water in a liquid electrolytic medium.

Advantageously, the electrode comprises a catalytic material obtained by the preparation process according to the invention and a binder.

The binder is preferably a polymer binder chosen for its capacities to be deposited in the form of a layer of variable thickness and for its capacities for ionic conduction in an aqueous medium and for diffusion of dissolved gases. The layer of variable thickness, advantageously of between 1 and 500 μm, in particular of the order of 10 to 100 μm, can in particular be a gel or a film.

Advantageously, the ionic conductive polymer binder is:

either conductive of anionic groups, in particular of hydroxy group, and is chosen from the group comprising in particular:
polymers stable in an aqueous medium, which can be perfluorinated, partially fluorinated or nonfluorinated and which exhibit cationic groups making possible the conduction of hydroxide anions, said cationic groups being of quaternary ammonium, guanidinium, imidazolium, phosphonium, pyridinium or sulfide type;
ungrafted polybenzimidazole;
chitosan; and
mixtures of polymers comprising at least one of the various polymers mentioned above, said mixture having anionic conductive properties;
   or conductive of cationic groups making possible the conduction of protons and is chosen from the group comprising in particular:
polymers which are stable in an aqueous medium, which can be perfluorinated, partially fluorinated or nonfluorinated and which exhibit anionic groups making possible the conduction of protons;
grafted polybenzimidazole;
chitosan; and
mixtures of polymers comprising at least one of the various polymers mentioned above, said mixture having cationic conductive properties.

Mention may in particular be made, among the polymers which are stable in an aqueous medium and which exhibit cationic groups making possible the conduction of anions, of polymer chains of perfluorinated type, such as, for example, polytetrafluoroethylene (PTFE), of partially fluorinated type, such as, for example, polyvinylidene fluoride (PVDF), or of nonfluorinated type, such as polyethylene, which will be grafted with anionic conductive molecular groups.

Among the polymers which are stable in an aqueous medium and which exhibit anionic groups making possible the conduction of protons, consideration may be given to any polymer chain stable in an aqueous medium containing groups such as —SO₃⁻, —COO⁻, —PO₃²—, —PO₃H⁻ or —C₆H₄O⁻.

Mention may in particular be made of Nafion®, sulfonated and phosphonated polybenzimidazole (PBI), sulfonated or phosphonated polyetheretherketone (PEEK).

In accordance with the present invention, any mixture comprising at least two polymers, one at least of which is chosen from the groups of polymers mentioned above, can be used, provided that the final mixture is ionic conductive in an aqueous medium. Thus, mention may be made, by way of example, of a mixture comprising a polymer stable in an alkaline medium and exhibiting cationic groups making possible the conduction of hydroxide anions with a polyethylene not grafted by anionic conductive molecular groups, provided that this final mixture is anionic conductive in an alkaline medium. Mention may also be made, by way of example, of a mixture of a polymer stable in an acidic or alkaline medium and exhibiting anionic or cationic groups making possible the conduction of protons or hydroxides and of grafted or ungrafted polybenzimidazole.

Advantageously, polybenzimidazole (PBI) is used in the present invention as binder. It is not intrinsically a good ionic conductor but, in an alkaline or acidic medium, it proves to be an excellent polyelectrolyte with respectively very good anionic or cationic conduction properties. PBI is a polymer generally used, in the grafted form, in the manufacture of proton conductive membranes for fuel cells, in membrane-electrode assemblies and in PEM-type electrolyzers, as an alternative to Nafion®. In these applications, the PBI is generally functionalized/grafted, for example by a sulfonation, in order to render it proton conductive. The role of PBI in this type of system is then different from that which it has in the manufacture of the electrodes according to the present invention, where it is used only as binder and has no direct role in the electrochemical reaction.

Even if its long-term stability in a concentrated acid medium is limited, chitosan, which can also be used as an anionic or cationic conductive polymer, is a polysaccharide exhibiting ionic conduction properties in a basic medium which are similar to those of PBI (G. Couture, A. Alaaeddine, F. Boschet and B. Ameduri, Progress in Polymer Science, 36 (2011), 1521-1557).

Advantageously, the electrode according to the invention is formulated by a process which additionally comprises a stage of removal of the solvent at the same time as or after stage 3). Removal of the solvent can be carried out by any technique known to a person skilled in the art, in particular by evaporation or phase inversion.

In the case of evaporation, the solvent is an organic or inorganic solvent, the evaporation temperature of which is less than the decomposition temperature of the polymer binder used. Mention may be made, by way of examples, of dimethyl sulfoxide (DMSO) or acetic acid. A person skilled in the art is capable of choosing the organic or inorganic solvent suitable for the polymer or for the polymer mixture used as binder and likely to be evaporated.

According to a preferred embodiment of the invention, the electrode is capable of being used for the electrolysis of water in an alkaline liquid electrolyte medium and the polymer binder is then an anionic conductor in an alkaline liquid electrolyte medium, in particular a conductor of hydroxides.

Within the meaning of the present invention, alkaline liquid electrolyte medium is understood to mean a medium, the pH of which is greater than 7, advantageously greater than 10.

The binder is advantageously conductive of hydroxides in an alkaline medium. It is chemically stable in electrolysis baths and has the capacity to diffuse and/or transport the OH⁻ ions involved in the electrochemical reaction to the surface of the particles, which are seats of redox reactions for the production of H₂ and O₂ gases. Thus, a surface which is not in direct contact with the electrolyte is all the same involved in the electrolysis reaction, a key point in the effectiveness of the system. The binder chosen and the shaping of the electrode do not hinder the diffusion of the gases formed and limit their adsorption, thus making possible their discharge. According to another preferred embodiment of the invention, the electrode is capable of being used for the electrolysis of water in an acidic liquid electrolyte medium and the polymer binder is a cationic conductor in an acidic liquid electrolyte medium, in particular conductive of protons.

Within the meaning of the present invention, acidic medium is understood to mean a medium, the pH of which is less than 7, advantageously less than 2.

A person skilled in the art, in the light of their general knowledge, will be capable of defining the the amounts of each component of the electrode. The density of the particles of catalytic material must be sufficient to reach their electrical percolation threshold.

According to a preferred embodiment of the invention, the polymer binder/catalytic material ratio by weight is between 5/95 and 95/5, preferably between 10/90 and 90/10 and more preferentially between 10/90 and 40/60.

### Process for the Preparation of the Electrode

The electrode can be prepared according to techniques well known to a person skilled in the art. More particularly, the electrode is formulated by a preparation process comprising the following stages:

1) at least one ionic conductive polymer binder is dissolved in a solvent or a solvent mixture;
2) at least one catalytic material prepared according to the invention, in powder form, is added to the solution obtained in stage 1) in order to obtain a mixture;
stages 1) and 2) being carried out in any order or simultaneously;
3) the mixture obtained in stage 2) is deposited on a metallic or metallic-type conductive support or collector.

Within the meaning of the invention, catalytic material powder is understood to mean a powder consisting of particles of micron, submicron or nanometer size. The powders can be prepared by techniques known to a person skilled in the art.

Within the meaning of the invention, metallic-type support or collector is understood to mean any conductive material having the same conduction properties as metals, for example graphite or certain conductive polymers, such as polyaniline and polythiophene. This support can have any shape making possible the deposition of the mixture obtained (between the binder and the catalytic material) by a method chosen from the group comprising in particular dipping, printing, induction, pressing, coating, spin coating, filtration, vacuum deposition, spray deposition, casting, extrusion or rolling. Said support or said collector can be continuous or openwork. Mention may be made, as example of support, of a grid (openwork support) or a plate or a sheet of stainless steel (304 L or 316 L, for example) (continuous supports).

The advantage of the mixture according to the invention is that it can be deposited on a continuous or openwork collector, by the usual easily accessible deposition techniques which make possible deposition in the forms of layers of variable thicknesses, ideally of the order of 10 to 100 μm.

In accordance with the invention, the mixture can be prepared by any technique known to a person skilled in the art, in particular by mixing the binder and the at least one catalytic material in powder form in a solvent or a mixture of solvents suitable for the achievement of a mixture with the rheological properties making possible the deposition of the electrode materials in the form of a film of controlled thickness on an electron conductive substrate. The use of the catalytic material in powder form makes possible maximization of the surface area developed by the electrodes and enhancement of the associated performance qualities. A person skilled in the art will be able to make the choices of the various formulation parameters in the light of their general knowledge and of the physicochemical characteristics of said mixtures.

### Operating Processes

Another subject matter according to the invention relates to an electrolysis device comprising an anode, a cathode and an electrolyte, in which at least one of the anode or of the cathode is an electrode according to the invention.

The electrolysis device can be used as water electrolysis device for the production of a gaseous mixture of hydrogen and oxygen and/or the production of hydrogen alone comprising an anode, a cathode and an electrolyte, said device being characterized in that one at least of the cathode or of the anode is an electrode according to the invention, preferably the cathode. The electrolysis device consists of two electrodes (an anode and a cathode, which are electron conductors) connected to a direct current generator and separated by an electrolyte (ionic conductive medium). The anode is the seat of the oxidation of the water. The cathode is the seat of the reduction of the protons and the formation of hydrogen.

The electrolyte can be:
either an acidic (H₂SO₄ or HCl, and the like) or basic (KOH) aqueous solution;
or a proton exchange polymer membrane which ensures the transfer of the protons from the anode to the cathode and makes possible the separation of the anode and cathode compartments, which prevents the entities reduced at the cathode from reoxidizing at the anode, and vice versa;
or a ceramic membrane conductive of O₂⁻ ions. Reference is then made to a solid oxide electrolysis (SOEC or Solid Oxide Electrolyzer Cell).

The minimum water supply of an electrolysis device is 0.8 l/Sm³ of hydrogen. In practice, the actual value is close to 1 l/Sm³. The water introduced must be as pure as possible because the impurities remain in the equipment and accumulate over the course of the electrolysis, ultimately disrupting the electrolytic reactions by:
the formation of sludges; and by
the action of chlorides on the electrodes.

An important specification with regard to the water relates to its ionic conductivity (which must be less than a few μS/cm).

There are many suppliers offering very diversified technologies, in particular in terms of the nature of the electrolyte and of associated technology, ranging from a possible upstream coupling with a renewable electricity supply (photovoltaic or wind power) to the direct final provision of pressurized hydrogen.

The reaction has a standard potential of −1.23 V, which means that it ideally requires a potential difference between the anode and the cathode of 1.23 V. A standard cell usually operates under a potential difference of 1.5 V and at ambient temperature. Some systems can operate at higher temperature. This is because it has been shown that the electrolysis under high temperature (HTE) is more efficient than the electrolysis of water at ambient temperature, on the one hand because a portion of the energy required for the reaction can be contributed by the heat (cheaper than electricity) and, on the other hand, because the activation of the reaction is more efficient at high temperature. HTE systems generally operate between 100° C. and 850° C.

The electrolysis device can be used as a nitrogen electrolysis device for the production of ammonia, comprising an anode, a cathode and an electrolyte, said device being characterized in that one at least of the cathode or anode is an electrode according to the invention, preferably the cathode.

The electrolysis device consists of two electrodes (an anode and a cathode, which are electron conductors) connected to a direct current generator and separated by an electrolyte (ionic conductive medium). The anode is the seat of the oxidation of the water. The cathode is the seat of the nitrogen reduction and the ammonia formation. Nitrogen is continuously injected into the cathode compartment.

The nitrogen reduction reaction is:

N₂+6H⁺+6e⁻→2NH₃

The electrolyte can be:
either an aqueous solution (Na₂SO₄ or HCl), preferably saturated with nitrogen;
or a proton exchange polymer membrane which ensures the transfer of the protons from the anode to the cathode and makes possible the separation of the anode and cathode compartments, which prevents the entities reduced at the cathode from reoxidizing at the anode, and vice versa.

The electrolysis device can be used as a carbon dioxide electrolysis device for the production of formic acid, comprising an anode, a cathode and an electrolyte, said device being characterized in that one at least of the cathode or of the anode is an electrode according to the invention. An example of anode and of electrolyte which can be used in such a device is described in detail in the document FR 3 007 427.

The electrolysis device can be used as a fuel cell device for the production of electricity from hydrogen and oxygen comprising an anode, a cathode and an electrolyte (liquid or solid), said device being characterized in that one at least of the cathode or of the anode is an electrode according to the invention.

The fuel cell device consists of two electrodes (an anode and a cathode, which are electron conductors) which are connected to a charge C for delivering the electric current produced and which are separated by an electrolyte (ionic conductive medium). The anode is the seat of the oxidation of the hydrogen. The cathode is the seat of the reduction of the oxygen.

The electrolyte can be:
either an acidic (H₂SO₄ or HCl, and the like) or basic (KOH) aqueous solution;
or a proton exchange polymer membrane which ensures the transfer of the protons from the anode to the cathode and makes possible the separation of the anode and cathode compartments, which prevents the entities reduced at the cathode from reoxidizing at the anode, and vice versa;
or a ceramic membrane conductive of O₂⁻ ions. Reference is then made to a solid oxide fuel cell (SOFC).

The following examples illustrate the present invention without, however, limiting the scope thereof. The examples below relate to the electrolysis of water in a liquid electrolytic medium for the production of hydrogen.

### EXAMPLES

### Example 1: Preparation of a Catalytic Material C1 (in Accordance with the Invention) From H₃PMo₁₂O₄₀, Ni(OH)₂ and Citric Acid

The catalytic material C1 (in accordance) is prepared by dry impregnation of 10 g of commercial carbon-type support (Ketjenblack®, 1400 m²/g) with 26 ml of solution. The solution is obtained by dissolving, in water, H₃PMo₁₂O₄₀ at a concentration of 2.6 mol/l, Ni(OH)₂, such that the Ni/Mo ratio=0.2, and citric acid, such that the citric acid/Mo ratio=0.5. The preparation of the catalyst is continued by a maturation stage where the impregnated solid is kept in a closed chamber, the atmosphere of which is saturated with water, for 12 hours before undergoing a drying stage at 60° C. (oil bath) under an inert atmosphere and at reduced pressure (while pulling under vacuum). The precatalyst is sulfurized under pure H₂S at a temperature of 400° C. for 2 hours under 0.1 MPa of pressure.

On the final catalyst, the amount of Mo corresponds to a surface density of 7 atoms per nm² and the Ni and P ratios are respectively: Ni/Mo=0.2 and P/Mo=0.08.

### Example 2: Description of the Commercial Pt Catalyst (Catalyst C2)

The material C2 originates from Alfa Aesar®: it comprises platinum particles with an S_{BET}=27 m²/g.

### Example 3: Catalytic Test

The characterization of the catalytic activity of the catalytic materials is carried out in a 3-electrode cell. This cell is composed of a working electrode, of a platinum counterelectrode and of an Ag/AgCl reference electrode. The electrolyte is a 0.5 mol/l aqueous sulfuric acid (H₂SO₄) solution. This medium is deoxygenated by sparging with nitrogen and the measurements are made under an inert atmosphere (deaeration with nitrogen).

The working electrode consists of a disk of glassy carbon with a diameter of 5 mm set in a Teflon tip (rotating disk electrode). Glassy carbon has the advantage of having no catalytic activity and of being a very good electrical conductor. In order to deposit the catalysts (C1, C2) on the electrode, a catalytic ink is formulated. This ink consists of a binder in the form of a solution of 10 μl of 15% by weight Nafion®, of a solvent (1 ml of 2-propanol) and of 5 mg of catalyst (C1, C2). The role of the binder is to ensure the cohesion of the particles of the supported catalyst and the adhesion to the glassy carbon. This ink is subsequently placed in an ultrasonic bath for 30 to 60 minutes in order to homogenize the mixture. 12 μl of the prepared ink are deposited on the working electrode (described above). The ink is subsequently deposited on the working electrode and then dried in order to evaporate the solvent.

Different electrochemical methods are used in order to determine the performance qualities of the catalysts:
linear voltammetry: it consists in applying, to the working electrode, a potential signal which varies with time, i.e. from 0 to −0.5 V vs RHE at a rate of 2 mV/s, and in measuring the faradaic response current, that is to say the current due to the oxidation-reduction reaction taking place at the working electrode. This method is ideal for determining the catalytic power of a material for a given reaction. It makes it possible, inter alia, to determine the overvoltage necessary for the reduction of the protons to give H₂.
chronopotentiometry: it consists, for its part, in applying a current or a current density for a predetermined time and in measuring the resulting potential. This study makes it possible to determine the catalytic activity at constant current but also the stability of the system over time. It is carried out with a current density of −10 mA/cm² and for a given time.

The catalytic performance qualities are collated in table 1 below. They are expressed as overvoltage at a current density of −10 mA/cm².

TABLE 1

| | Overvoltage at −10 mA/cm² |
|---|---|
| Catalytic materials | [(mV) vs RHE] |
| C1 | −190 |
| C2 (Platinum) | −90 |

With an overvoltage of only −190 mV vs RHE, the catalytic material C1 exhibits performance qualities relatively close to those of platinum with regard to the prior art. This result demonstrates the indisputable advantage of this material for the development of the water electrolysis hydrogen sector.

1. A process for the preparation of a catalytic material of an electrode for electrochemical reduction reactions, said material comprising an active phase based on at least one metal from group VIb and an electroconductive support, which process is carried out according to at least the following stages:
a) a stage of bringing said support into contact with at least one solution containing at least one precursor of at least one metal from group VIb;
b) optionally a stage of bringing the support into contact with an organic additive, it being understood that stage b) is obligatory when said precursor of at least one metal from group VIb according to stage a) is chosen from polyoxometallates corresponding to the formula (HₕXₓMₘO_{y})^{q-} in which H is hydrogen, X is an element chosen from phosphorus (P), silicon (Si), boron (B), nickel (Ni) and cobalt (Co), M is one or more metal(s) chosen from molybdenum (Mo), tungsten (W), nickel (Ni), cobalt (Co) and iron (Fe), 0 being oxygen, h being an integer between 0 and 12, x=0, m being an integer equal to 5, 6, 7, 8, 9, 10, 11, 12 and 18, y being an integer between 17 and 72 and q being an integer between 1 and 20, it being understood that M is not a nickel atom, a cobalt atom or an iron atom alone.
stages 1) and 2), if both carried out, being carried out in any order or simultaneously;
c) a drying stage on conclusion of stage a), optionally of the sequence of stages a) and b) or b) and a), at a temperature of less than 250° C., without a subsequent calcination stage;
d) a stage of sulfurization of the material obtained on conclusion of stage c) at a temperature of between 100° C. and 600° C.

2. The process as claimed in claim 1, in which said precursor of at least one metal from group VIb is chosen from polyoxometallates corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20; salts of precursors of the elements from group VIb, such as molybdates, thiomolybdates, tungstates or also thiotungstates; organic or inorganic precursors based on Mo or W, such as MoCl₅ or WCl₄ or WCl₆, and Mo or W alkoxides.

3. The process as claimed in claim 1, in which the m atoms M are either solely molybdenum (Mo) atoms, or solely tungsten (W) atoms, or a mixture of molybdenum (Mo) and tungsten (W) atoms, or a mixture of molybdenum (Mo) and cobalt (Co) atoms, or a mixture of molybdenum (Mo) and nickel (Ni) atoms, or a mixture of tungsten (W) and nickel (Ni) atoms.

4. The process as claimed in claim 1, in which the m atoms M are either a mixture of nickel (Ni), molybdenum (Mo) and tungsten (W) atoms or a mixture of cobalt (Co), molybdenum (Mo) and tungsten (W) atoms.

5. The process as claimed in claim 1, comprising an additional stage of introduction of at least one promoter comprising at least one metal from group VIII by a stage of bringing said support into contact with at least one solution containing at least one precursor of at least one metal from group VIII.

6. The process as claimed in claim 1, in which a maturation stage is carried out after stage a) and/or b) but before stage c), at a temperature of between 10° C. and 50° C. for a period of time of less than 48 hours.

7. The process as claimed in claim 1, in which the drying stage c) is carried out at a temperature of less than 180° C.

8. The process as claimed in claim 1, in which, when the precursor of the catalytic material comprises at least one metal from group VIb and at least one metal from group VIII, the sulfurization temperature in stage d) is between 350° C. and 550° C.

9. The process as claimed in claim 1, in which, when the precursor of the catalytic material comprises solely a metal from group VIb, the sulfurization temperature in stage d) is between 100° C. and 250° C. or between 400° C. and 600° C.

10. The process as claimed in claim 1, in which the organic additive is chosen from:
chelating agents, nonchelating agents, reducing agents or nonreducing agents;
mono-, di- or polyalcohols, carboxylic acids, sugars, noncyclic mono-, di- or polysaccharides, esters, ethers, crown ethers, cyclodextrins and organic compounds containing sulfur or nitrogen.

11. The process as claimed in claim 1, in which the support comprises at least one material chosen from carbon structures of carbon black, graphite, carbon nanotubes or graphene type.

12. The process as claimed in claim 1, in which the support comprises at least one material chosen from gold, copper, silver, titanium or silicon.

13. An electrode, characterized in that it is formulated by a preparation process comprising the following stages:
1) at least one ionic conductive polymer binder is dissolved in a solvent or a solvent mixture;
2) at least one catalytic material prepared according to claim 1, in powder form, is added to the solution obtained in stage 1) in order to obtain a mixture;
stages 1) and 2) being carried out in any order or simultaneously;
3) the mixture obtained in stage 2) is deposited on a metallic or metallic-type conductive support or collector.

14. An electrolysis device comprising an anode, a cathode and an electrolyte, said device being characterized in that one at least of the anode or of the cathode is an electrode as claimed in claim 13.

15. A method for performing an electromechanical reaction, comprising performing said reaction by the electrolysis device according to claim 14.

16. The method as claimed in claim 15, in which said device perform as:
water electrolysis device for the production of a gaseous mixture of hydrogen and oxygen and/or the production of hydrogen alone;
carbon dioxide electrolysis device for the production of formic acid;
nitrogen electrolysis device for the production of ammonia;
fuel cell device for the production of electricity from hydrogen and oxygen.
